(19) United States
(12) Patent Application Publication
(10) Pub. No.: US 2008/0182224 A1
(43) Pub. Date: Jul. 31, 2008

(54) DELIVERY SYSTEM

(76) Inventor: David J. Ahearn, Little Compton, RI (US)

Correspondence Address: BARLOW, JOSEPHS & HOLMES, LTD., 101 DYER STREET, 5TH FLOOR, PROVIDENCE, RI, 02903, US

(21) Appl. No.: 12/021,869

(22) Filed: Jan. 29, 2008

Related U.S. Application Data
(60) Provisional application No. 60/886,983, filed on Jan. 29, 2007.

(51) Int. Cl. A61G 15/16

(52) U.S. Cl. 433/77

(57) ABSTRACT

The present invention is a delivery system that conceals instruments and supplies to reduce patient anxiety while also providing an additional storage area that is accessible in an ergonomically acceptable manner by the user. The delivery system contains a delivery platform and a storage unit. The delivery platform has a base connected to a primary work surface area. The primary work surface area is capable of storing instruments and supplies. A storage unit has an outer surface attached to a wall surface proximal to the delivery platform. The storage unit has an inner surface containing a secondary work surface area capable of storing instruments and supplies designed to supplement the primary work surface area. In addition, a cover is hingedly connected to the outer surface of the storage unit to conceal the secondary work surface area from direct view of a patient.

### CROSS REFERENCE TO RELATED APPLICATION

This application is related to and claims priority from earlier filed provisional patent application Ser. No. 60/886,983, filed Jan. 29, 2007 and incorporated herein by reference.

### BACKGROUND OF THE INVENTION

The present invention relates generally to delivery systems for medical environments. In particular, the present invention relates to ergonomic delivery systems that have particular application for use in dental office environments.

The ideal dental treatment room is constructed and equipped to provide essential dental services as effectively and efficiently as possible. With this goal in mind, various prior art dental carts have been designed to provide a mobile work surface, with internal cabinetry for access to dental instruments and supplies. See, for example Slouka, U.S. Pat. No. 3,597,033; Tocchini, U.S. Pat. No. 3,229,368; and Elliot, U.S. Design Pat. No. 302,585. In addition, there exist more expansive dental work stations and treatment room cabinet structures that also attempt to achieve minimum doctor time and motion and maximum efficiency. See Wolf et al., U.S. Pat. No. 4,013,328; and Fuchs, U.S. Pat. No. 4,934,933.

Unfortunately, the prior art dental carts omit the ergonomically beneficial design. In the prior art, the prior art work surfaces provide storage for instruments and supplier without any focus on the need for user comfort and reach. Most importantly, in a dental environment, the prior art dental carts require repetitive motion by a user to reach, stand, or lean over to gain access to critical supplies or instruments during operative procedures.

The rapid increase in technology and instrumentation in the dental treatment room in recent years has also rendered many of the prior art designs obsolete in view of the additional storage needed within reach of the user. In order to be effective a dental delivery platform must provide easy access to a growing variety of instruments, resins, implants and various consumables, as well as X-ray and computer equipment. The prior art designs considered herein fail to fully satisfy the requirement for additional storage and ergonomically beneficial design.

In medicine, such as dentistry, and other fields there is a need for an operative area that not only makes the environment more efficient for the practitioner but also reduces patient anxiety. There is also a need to provide an environment and a delivery system for the practitioner user that is highly efficient, functional, or ergonomically beneficial with immediate and direct access to instruments and supplies. However, this need for an efficient and functional delivery system with easy access to instruments competes directly with the need to conceal such instruments and supplies from the patient to reduce anxiety. Due to added complexities of medical and dental procedures, there is a further need for additional materials and supplies and deployment of those materials and supplies. Current systems are deficient because these materials and supplies are currently placed outside the operator's optimal range of motion. Thus, there is a need for making the materials and supplies within the operator's range of motion, while accommodating these other objectives.

There have been very few attempts in the prior art to simultaneously address these competing needs. For example, prior art delivery systems simply provide instruments and supplies on a static shelf in a cabinet nearby the patient workspace. While such a location is, indeed, concealed from the patient to reduce anxiety, it is positioned in a location remote from the practitioner making it difficult to easily access the instruments and supplies. As a result, access to the full range of instruments in these prior art systems are severely restricted making such delivery systems unsatisfactory for use. It is also possible in the prior art to store instruments and supplies on a roll away cart, however, these are not ergonomically sound and have limited storage space. Further this mobile storage is either too low for functional use or less than stable if the unit is at working height.

Therefore, there is a need in for a delivery system that can both effectively conceal instruments and supplies from the patient to reduce anxiety while also providing an ergonomic delivery system with direct and easy access to instruments and supplies. There is also a need to increase the storage area for instruments and supplies while still making it capable of being concealed from the patient. There is a need to reduce the weight of a concealable delivery system that can save space while increasing access to instruments and supplies.

### BRIEF SUMMARY OF THE INVENTION

The present invention preserves the advantages of prior art delivery systems. In addition, it provides new advantages not found in currently available delivery systems and overcomes many disadvantages of such currently available delivery systems.

The present invention is a delivery system that conceals instruments and supplies to reduce patient anxiety while also providing an additional storage area that is ergonomically beneficial and accessible by the user. The delivery system contains a delivery platform and a storage unit. The delivery platform has a base connected to a primary work surface area. The base contacting a floor surface or arm-supported. The primary work surface area capable of storing instruments and supplies.

A storage unit is positioned proximal to the delivery platform to provide additional storage area for concealing supplies and instruments. The storage unit has an outer surface and an inner surface. The outer surface is attached to a wall surface proximal to the delivery platform. The inner surface contains a shelf unit having a secondary work surface area capable of storing instruments and supplies to supplement the primary work surface area.

A guiding mechanism for moving the shelf unit proximal to the primary work surface area is attached to the storage unit. The guiding mechanism has a first end and a second end. The first end of the guiding mechanism is attached to the inner surface of the storage unit. The second end of the guiding mechanism is slidably attached to the shelf unit. To conceal the secondary work surface area, a cover is hingedly connected to the storage unit to prevent a direct view of by patient and thereby reducing anxiety.

The shelf unit has one or more tiers for additional storage of instruments and supplies proximal to the primary work surface area. Optionally, a slide-out tier is slidably attached to the shelf unit to store additional items such as a wireless keyboard or monitor. The delivery system may also include an operating platform, such as a dental chair, positioned proximal to the storage unit and the delivery platform.

In operation, the cover is hingedly moved above the storage unit and the shelf unit is slidably moved along the guiding mechanisms downwardly from the storage unit. As a result, the shelf unit provides a secondary work surface area proximal to the primary surface area for additional storage.

It is therefore an object of the present invention to provide a delivery system for concealing instruments and supplies to reduce patient anxiety.

It is a further object of present invention to provide an ergonomic delivery system which provides a large storage area that is directly and immediately accessible by the user.

Another object of the present invention is to provide a delivery system that can be multi-tiered to enable large volumes of storage.

A further object of the present invention is to provide a delivery system that facilitates the usage of space for treatment and consultation.

Other objects, features and advantages of the invention shall become apparent as the description thereof proceeds when considered in connection with the accompanying illustrative drawings.

### BRIEF DESCRIPTION OF THE DRAWINGS

The novel features which are characteristic of the delivery system are set forth in the appended claims. However, the delivery system, together with further embodiments and attendant advantages, will be best understood by reference to the following detailed description taken in connection with the accompanying drawings in which:

FIG. 1 is a perspective view of a prior art delivery platform;

FIG. 2 is a front view of the present invention with the shelf unit extended from the storage unit;

FIG. 3 is a plan view of the present invention of FIG. 1;

FIG. 4 is a perspective view of the storage unit without a cover of FIG. 1 with the shelf unit retracted within the storage unit;

FIG. 5 is a perspective view of the storage unit without a cover of FIG. 1 showing the shelf unit extended from the storage unit.

FIG. 6 is a perspective view of the storage unit of FIG. 1 without a cover showing an linkage mechanism for rotating the shelf unit;

FIG. 7 is a side view of an embodiment of the present invention using a mobile delivery platform;

FIG. 8 is a front view of the present invention with the shelf unit concealed inside the storage unit;

FIG. 9 is a front view of the present invention with the shelf unit beginning to extend from the storage unit;

FIG. 10 is top view of the present invention with the shelf unit fully extended from the storage unit; and

FIG. 11 is front view of the present invention with the slide-out tier extended from the shelf unit.

### DETAILED DESCRIPTION OF PREFERRED EMBODIMENT

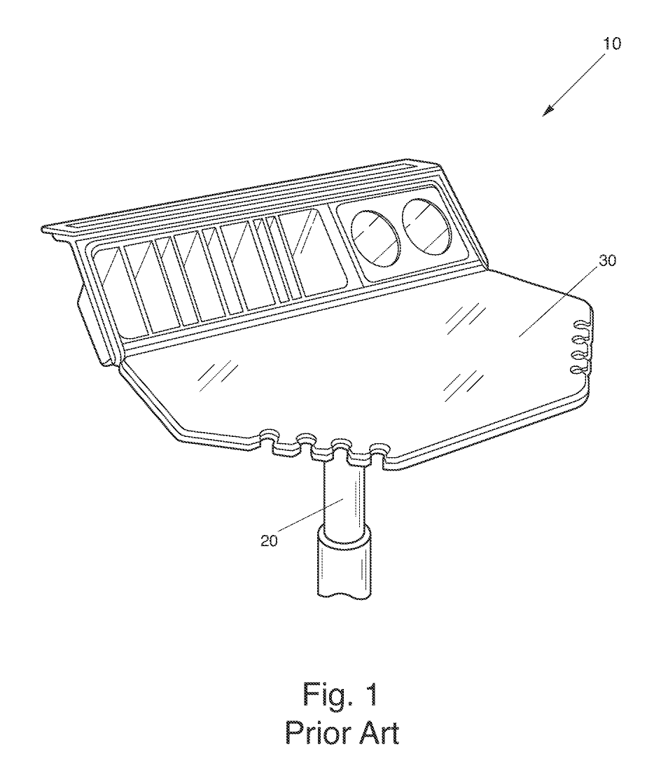

As shown in FIG. 1, a delivery platform known in the prior art is shown. The delivery platform 10 (U.S. Pat. No. 6,056,129) of the prior art has a base 20 for attachment to a floor surface or arm-supported workstation. The base 20 is connected by a variety of means to the primary work surface area 30 for storing instruments and supplies. The problems with the primary work surface area 30 are the limited room for storage and it provides a direct view to patient items that may cause anxiety to a patient. To overcome these problems of the delivery platform 10, a new and improved delivery system 40 is disclosed herein.

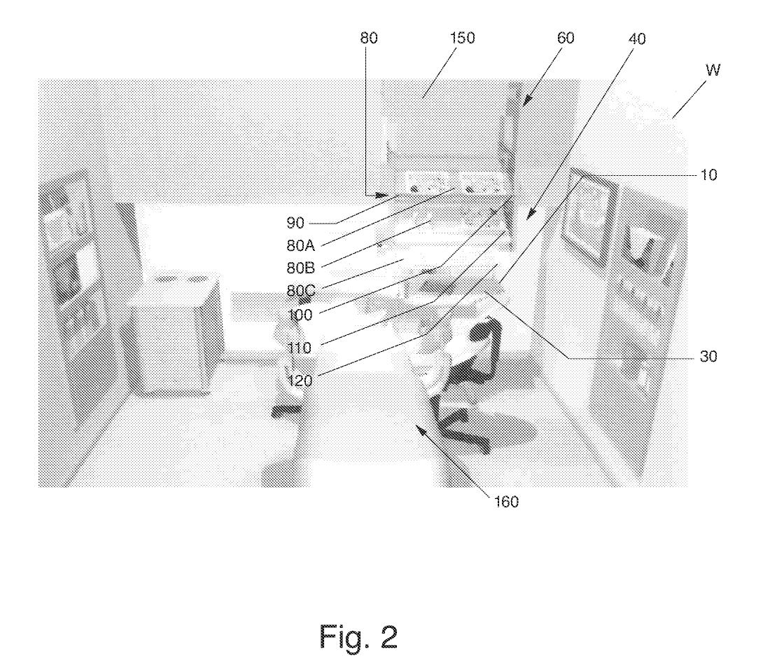

Referring to FIGS. 2-11, the present invention provides a new and novel ergonomic delivery system 40 that is improved over prior art delivery systems. The delivery system 40 of the present invention conceals instruments and supplies to reduce patient anxiety while also providing a large storage area that is directly and ergonomically accessible by the user. Also, the delivery system 40 is multi-tiered to enable large volumes of storage while still being concealable and ergonomic.

Referring to FIG. 2, the delivery system 40 is shown as used in a representative environment, such as a dental office. The delivery system 40 contains a delivery platform 10 (FIG. 1) and a storage unit 60 proximal to the delivery platform 10. It should be noted that the delivery system may also be the storage unit 60 alone without the delivery platform 10.

As shown in FIG. 1, the delivery platform 10 has a base 20 connected to a primary work surface area 30. The base 20 contacting a floor surface or arm-supported and the primary work surface area 30 capable of storing instruments and supplies. FIG. 1 provides merely an example, shown in U.S. Pat. No. 6,056,129, of a delivery platform 10 that may be used in the delivery system 40. Any other type of delivery platform 10 having a base 20 connected to a primary work surface area 30 may be used. It should also be noted that a mobile delivery platform 70, such as a dental cart, may also be used.

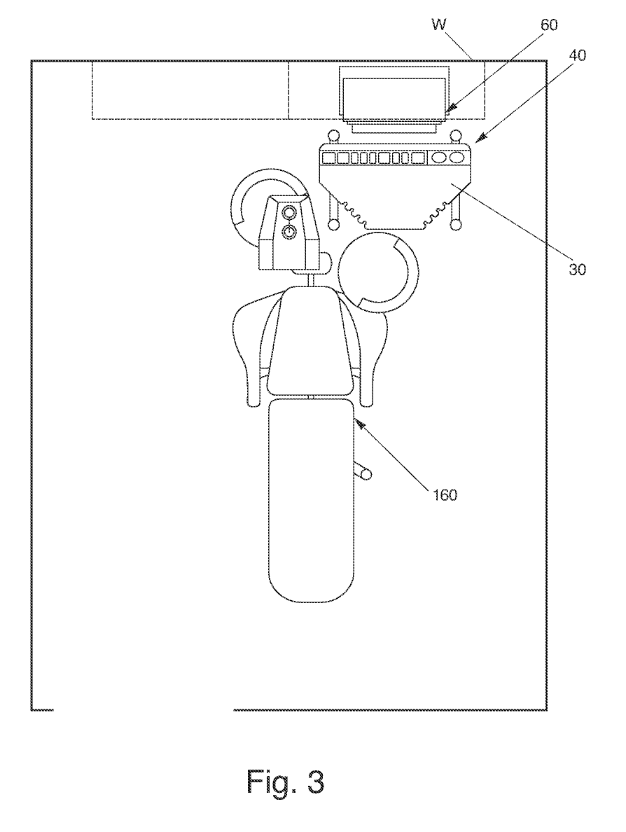

Referring to FIG. 3, a plan view of the present invention is shown. The storage unit 60 is positioned proximal to the delivery platform 10 for supplemental storage area and for concealing supplies and instruments. The storage unit 60 has an outer surface 60A and an inner surface 60B. The outer surface 60A of the storage unit 60 is attached to a wall surface W proximal to the delivery platform 10. Alternatively, the storage unit 60 may be attached to a wall surface W proximal to a chair 160.

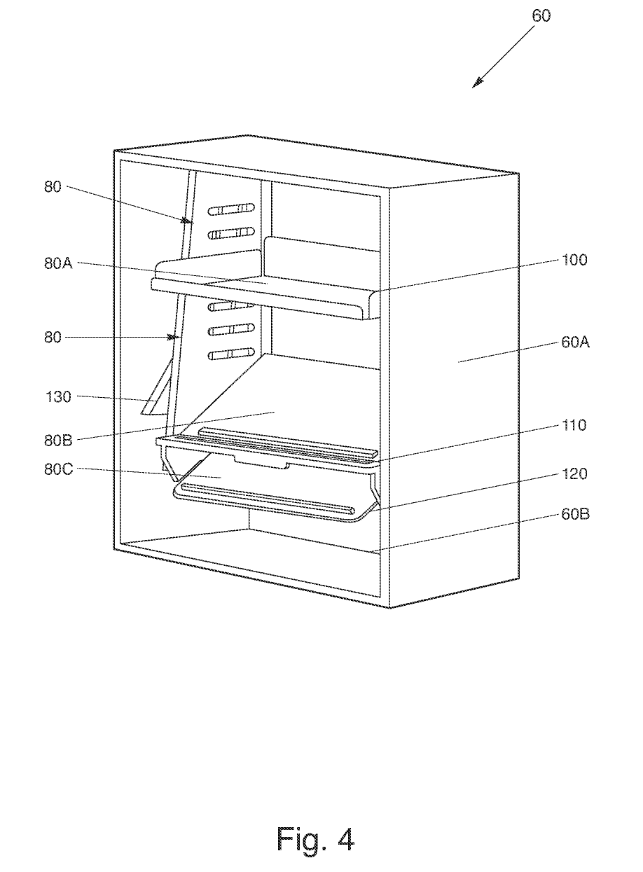

Referring to FIG. 4, the inner surface 60B of the storage unit 60 contains a shelf unit 80 having a secondary work surface area 80A,80B,80C. The secondary work surface area 80A,80B,80C is capable of storing instruments and supplies to supplement the primary work surface area 30. The secondary work surface area 80A,80B,80C increases access to instruments and supplies for user and reduces weight placed on primary work surface area 30. In one embodiment, the secondary work surface area 80A,80B,80C is seven square feet or more.

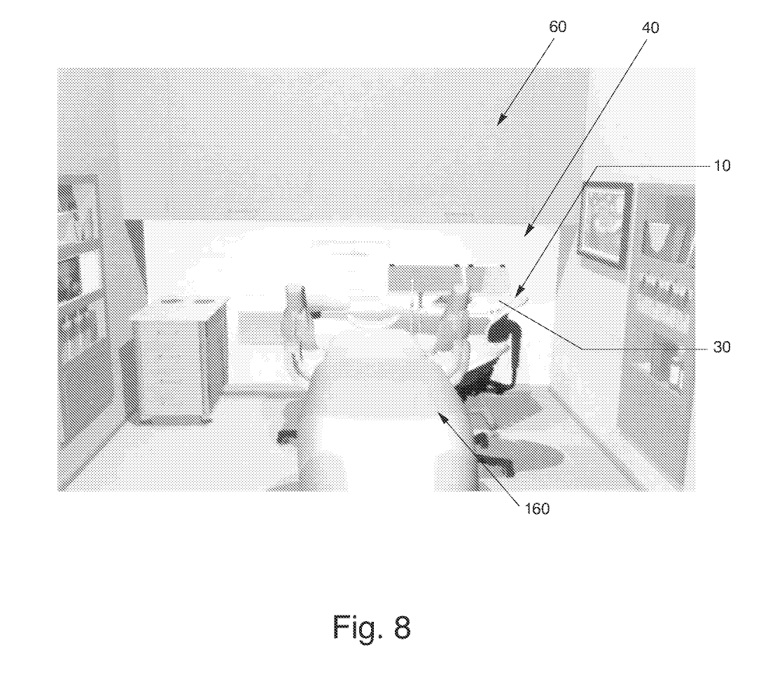

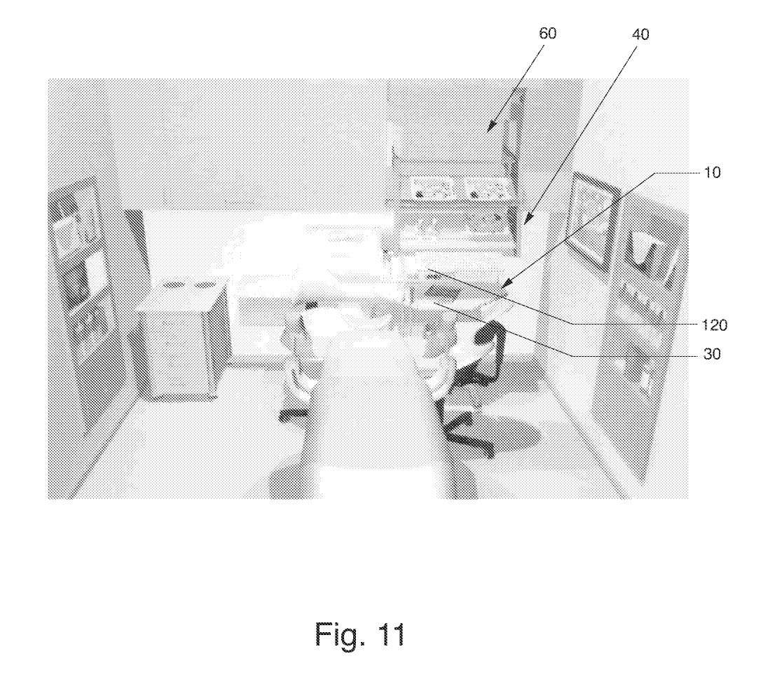

Referring back to FIG. 2, a cover 150 is hingedly connected to the outer surface 60A of the storage unit 60 to conceal the shelf unit 80. The cover 150 contains at least one member which is hingedly moved above the storage unit 60. Alternatively, the cover 150 may be at least one door that moves sidewardly of the storage unit 60. The cover 150, when in a closed position (see FIG.8), conceals the retracted shelf unit 80 including the secondary work surface area 80A,80B,80C. The cover 150, when in an open position (see FIG. 11), allows the shelf unit 80 to expand downward into a position proximal to the primary work surface area 30.

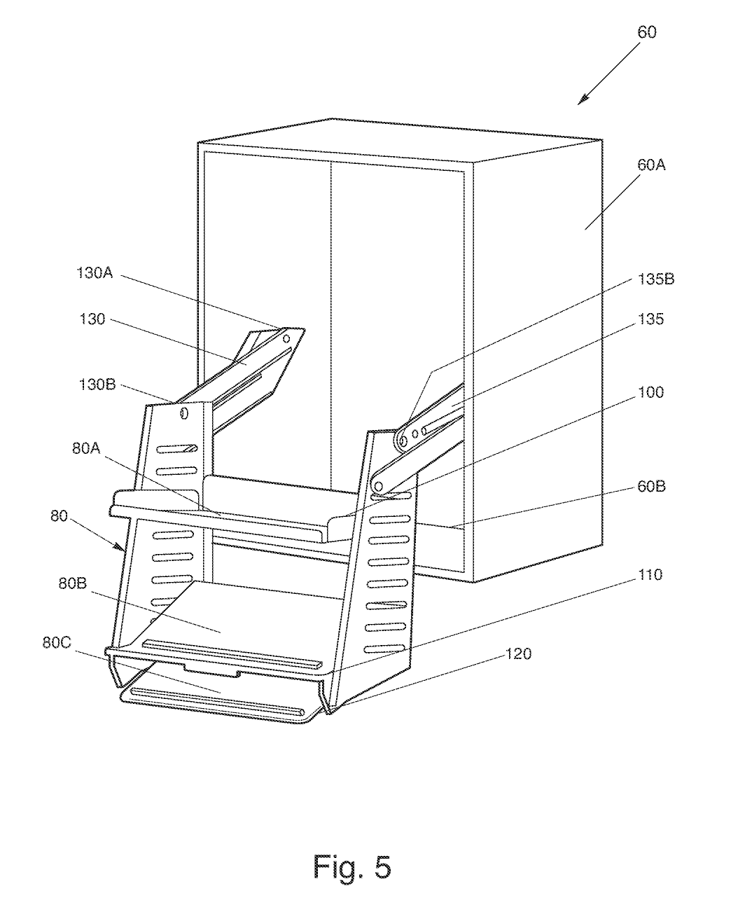

Referring now to FIG. 5, the shelf unit 80 has one or more tiers 100,110,120 for additional storage of instruments and supplies proximal to the primary work surface area 30. Preferably, the storage unit has three tiers 100,110,120. The tiers 100,110,120 are angled downward towards the user for increased ergonomic access and convenience. Optionally, a slide-out tier 120 is slidably attached to the shelf unit 80 to store additional items such as a wireless keyboard or monitor. It should be noted that the extended shelf unit 80 can be reachable by practitioner while seated or standing from the front, side, or rear of the shelf unit 80. Also, a secondary work surface area can be provided by means other than the shelf unit 80.

Referring to FIG. 5, guiding mechanisms 130,135 are used for moving the shelf unit 80 proximal to the primary work surface area 30. The guiding mechanisms 130,135 have a first end 130A,135A and a second end 130B,135B. The first end 130A,135A of the guiding mechanism 130,135 is attached to the inner surface 60B of the storage unit 60 for moving the shelf unit 80 proximal to the primary work surface area 30. The second end 130B,135B of the guiding mechanism 130,135 is slidably attached to an upper end of the shelf unit 80. Preferably, the guiding mechanism 130,135 lowers the shelf unit 80 to provide access to a user whether seated or standing.

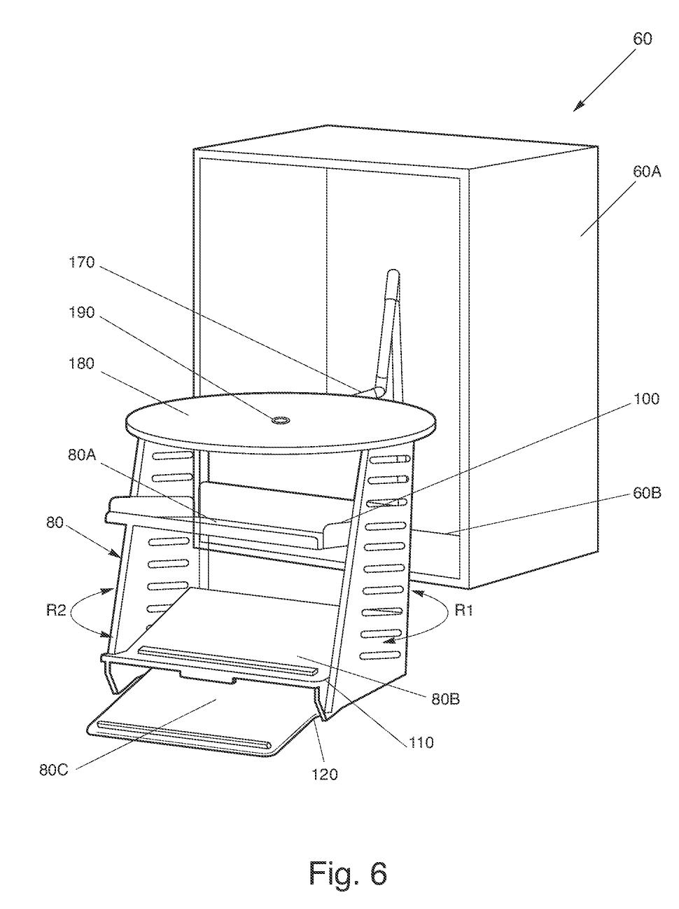

Referring to FIG. 6, in another embodiment of the present invention, the shelf unit 80 may be twisted or rotated in direction R1 or R2. The shelf unit 80 is rotatably attached to a plate 180 to provide swivel movement around a vertical axis point 190. A linkage mechanism 170 is attached to the 180 and the storage unit 60. In operation, the shelf unit 80 is extended from the storage unit using the linkage mechanism 170 and then rotated according to a user's need.

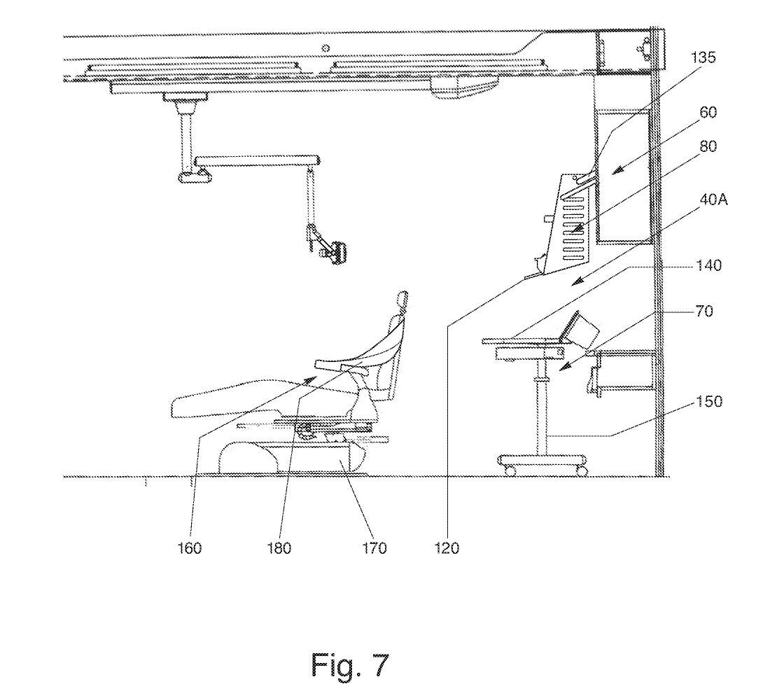

Referring to FIG. 7, an alternative embodiment of the present invention is shown. The delivery system 40A of FIG. 7 has all of the recited features and attributes of the delivery system 40 of FIG. 2 except for the use of a mobile delivery platform 70 in place of the delivery platform 10. The mobile delivery platform 70 has a base 150 connected to a primary work surface area 140 for storing instruments and supplies. The mobile delivery platform 70 provides a user the ability to convert from a right hand orientation to a left hand orientation of the representative room. For instance, the user can move the mobile delivery platform 70 from underneath a storage unit 60 on the right side of the room and move it underneath a storage unit 60 on the left side of the room.

Referring to FIGS. 8-11, the present invention is shown in operation from a fully concealed position (FIG. 8) to a fully open position (FIG. 11). Referring to FIG. 8, the delivery system 40 is in a fully concealed position, which is appropriate for patient arrival. Next, the patient (not shown) is seated in the chair 160, which is shown reclined in preparation for the practitioner to deliver treatment. Once the patient is at rest, the delivery system 40 of the present invention can now be actuated.

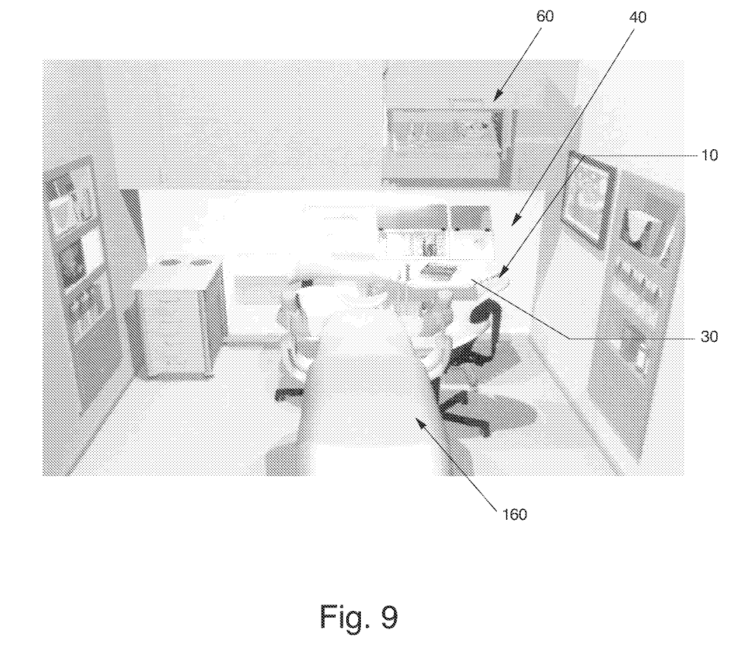

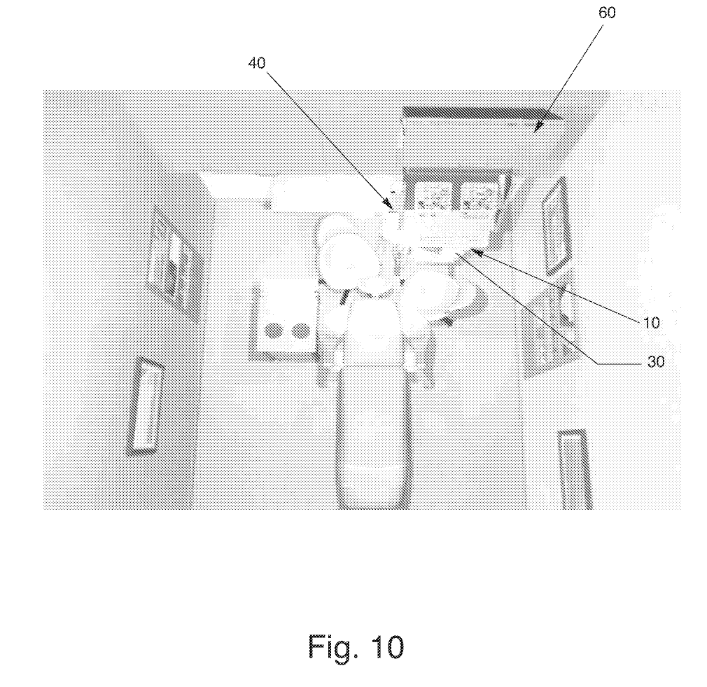

Referring to FIG. 9, the delivery system 40 is shown at the beginning of deployment. More specifically, the cover 150 is hingedly moving above the storage unit 60 and the shelf unit 80 is exposed. Referring to FIGS. 10 and 11, the delivery system 40 is shown fully deployed. The shelf unit 80 has been moved downwardly along the guide mechanism 130, 135 proximal to the delivery platform 10 to provide additional storage. The tiers 100,110,120 of the shelf unit 80 are now positioned for ergonomically beneficial access by the practitioner. Also, the slide-out tier 120 containing the keyboard has been slidably moved proximal to a user. At this point, a practitioner can treat a patient with the necessary instruments and supplies directly at hand and ergonomically accessible from either the primary work surface area 30 or the secondary work surface area 80A,80B,80C.

As can be understood, when treatment is completed on the patient, the delivery system 40 can be easily and quickly stowed up and away and thereby concealed back to the fully concealed position of FIG. 8. In a fully concealed position (FIG. 8), the patient can exit the workspace without having a direct view of instruments or supplies thereby further reducing the anxiety of the treatment experience and securing the space.

It should also be noted that both delivery systems (40,40A) may also include an operating platform 160, such as a dental chair that can incline and recline positions for a patient, proximal to the primary 30 and secondary work surface area 80. The operating platform 160 has a base 170 connected to a third work surface area 180. The operating platform 160 may be positioned proximal to the storage unit 60 and/or delivery platform 10 to provide additional storage area.

It should be understood that the delivery system 40 is well-suited and preferably used in a dental, ophthalmic and oral surgery office environment, such as for dental or ophthalmic treatment delivery, however, it may be used in any environment where a patient or person needs to be supported. In fact, the present invention may be used in any environment that requires access to instruments and supplies and where there is a desire to conceal, secure or isolate such items from a patient and where easy access thereof is required. The invention will be disclosed herein in connection with use in a dental office environment, however, the present invention is not intended to be limited to that particular use or environment.

In view of the foregoing, a new and novel improved ergonomic delivery system 40 is provided. The delivery system 40 can both easily and quickly conceal instruments and supplies to reduce patient anxiety while also providing a large storage area that is directly and ergonomically accessible by the user. Also, the delivery system 40 of the present invention can be multi-tiered to enable large volumes of storage while still being concealable and ergonomic. These features in a single delivery system 40 cannot be achieved in prior art delivery systems.

Therefore, while there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A delivery system, comprising:
a delivery platform having a base connected to a primary work surface area, the primary work surface area capable of storage;
a storage unit having an inner surface and an outer surface, the outer surface attached to a wall proximal to the delivery platform, the inner surface containing a secondary work surface area capable of storage; and
whereby the storage unit provides a secondary work surface area proximal to the primary work surface area to provide additional area for storage.

2. The delivery system of claim 1, further comprising:
a cover hingedly connected to the outer surface of the storage unit to conceal the secondary work surface area from direct view of a patient.

3. The delivery system of claim 1, wherein the secondary work surface area is at least one shelf unit having at least one tier.

4. The delivery system of claim 3, further comprising:
a guiding mechanism having a first end and a second end, the first end attached to the inner surface of the storage unit, the second end slidably attached to the shelf unit for movement downwardly towards the primary work surface area.

5. The delivery system of claim 3, wherein the shelf unit has one or more tiers for additional storage of instruments and supplies.

6. The delivery system of claim 3, further comprising:
at least one slide-out tier slidably connected to at least one shelf unit.

7. The delivery system of claim 1, wherein the storage unit is proximal an operating platform.

8. A delivery system, comprising:
a delivery platform having a base connected to a primary work surface area, the primary work surface area capable of storage;
a storage unit having an inner surface and an outer surface;
the inner surface of the unit containing a shelf unit having a secondary work surface area, at least three tiers of the shelf unit are angled downwardly towards a user;
a guide mechanism having a first end and a second end, the first end is attached to the inner surface of the storage unit, the second end is slidably attached to the shelf unit;
the outer surface of the unit attached to a wall proximal to the delivery platform;
a cover hingedly connected to the outer surface of the storage unit to conceal the secondary work surface area from direct view of a patient; and
whereby the cover is hinged open above the storage unit and the shelf unit is slidably moved along the guiding mechanisms downwardly from the storage unit, as a result, the shelf unit provides the secondary work surface area proximal to the primary surface area for additional storage.

9. The delivery system of claim 8, wherein at least one of the three tiers is a slide-out tier slidably connected to the shelf unit.

10. A delivery system, comprising:
a delivery platform having a base connected to a primary work surface area, the primary work surface area capable of storage;
a storage unit having an inner surface and an outer surface, the outer surface attached to a wall proximal to the chair, the inner surface containing a secondary work surface area capable of storage;
an operating platform having a third work surface area, the third work surface area capable of storage; and
whereby the storage unit provides a secondary work surface area proximal to the primary and third work surface area to provide additional area for storage.
